(19) United States
(12) Patent Application Publication
(10) Pub. No.: US 2019/0270653 A1
(43) Pub. Date: Sep. 5, 2019

(54) ULTRAPURE WATER PRODUCTION METHOD AND ULTRAPURE WATER PRODUCTION SYSTEM

(71) Applicant: NOMURA MICRO SCIENCE CO., LTD., Atsugi-shi (JP)

(72) Inventor: Toru Amaya, Atsugi-shi (JP)

(73) Assignee: NOMURA MICRO SCIENCE CO., LTD., Atsugi-shi (JP)

(21) Appl. No.: 16/418,253

(22) Filed: May 21, 2019

Related U.S. Application Data
(63) Continuation of application No. PCT/JP2017/040274, filed on Nov. 8, 2017.

(30) Foreign Application Priority Data
Nov. 25, 2016 (JP) 2016-229194

(51) Int. Cl. C02F 1/44; C02F 1/28; C02F 1/469; B01D 61/02; B01D 61/04; B01D 61/08; B01D 61/48; B01D 61/58; B01D 69/02; C02F 9/00

(52) U.S. Cl. CPC C02F 1/441; C02F 2101/12; C02F 1/4695; B01D 61/022; B01D 61/025; B01D 61/04; B01D 61/08; B01D 61/48; B01D 61/58; B01D 69/02; C02F 9/00; B01D 2311/04; B01D 2311/06; B01D 2311/2626; B01D 2311/2684; B01D 2325/30; B01D 2311/25; C02F 1/283

(57) ABSTRACT

An object of the present invention is to provide an ultrapure water production method and an ultrapure water production system that are capable of suppressing deterioration in a two-stage reverse osmosis membrane device of the ultrapure water production system caused by an oxidant and further suppressing occurrence of biofouling. The ultrapure water production method using an ultrapure water production system including a two-stage reverse osmosis membrane device including a chlorine-resistant reverse osmosis membrane device at a previous-stage and a non-chlorine-resistant reverse osmosis membrane device to perform a treatment at a subsequent-stage, and the method comprises treating a water-to-be-treated having a total of a free chlorine concentration in Cl equivalent and a free bromine concentration in Br equivalent of 0.01 mg/L or more and less than 0.1 mg/L using the chlorine-resistant reverse osmosis membrane device followed by the non-chlorine-resistant reverse osmosis membrane device of the two-stage reverse osmosis membrane device.

### CROSS-REFERENCE TO RELATED APPLICATIONS

This application is a continuation of prior International Application No. PCT/JP2017/040274 filed on Nov. 8, 2017 which is based upon and claims the benefit of priority from Japanese Patent Application No. 2016-229194 filed on Nov. 25, 2016; the entire contents of all of which are incorporated herein by reference.

### FIELD

The present invention relates to an ultrapure water production method and an ultrapure water production system.

### BACKGROUND

Ultrapure water used for a semiconductor manufacturing process has been conventionally produced by an ultrapure water production system composed of a plurality of treatment processes. The ultrapure water production system is composed of, for example, a pretreatment unit that removes suspended matters and so on in raw water, a primary pure water production unit that removes total organic carbon (TOC) components and ion components in pre-treated water treated by the pretreatment unit using a two-stage reverse osmosis membrane device connected in two stages in series, and a secondary pure water production unit that removes impurities in an ultramicro quantity in primary pure water obtained by the primary pure water production unit. In the ultrapure water production system, as the raw water, tap water, well water, ground water, industrial water, used ultrapure water (recovered water) that is recovered at a point of use (POU) to be treated, and so on are used (see Patent References 1 (J-P-A 2004-33976) and 2 (WO 2009/016982), for example).

Here, tap water, well water, ground water, industrial water, and so on are sterilized by an oxidant such as hypochlorous acid or hypobromous acid, so that the total of concentrations of free chlorine and free bromine remaining in the water (the free chlorine and the free bromine will be hereinafter referred to as a “free oxidant” collectively) sometimes exceeds 0.1 mg/L. As a reverse osmosis membrane used for the reverse osmosis membrane device in the primary pure water production unit, a polyamide-based composite membrane is often used because its impurity removal rate is high. However, when the above-described raw water passes through the polyamide-based composite membrane, deterioration in the polyamide-based composite membrane is accelerated by the remaining free oxidant.

In a general polyamide-based reverse osmosis membrane, an allowable concentration of the remaining free oxidant that does not cause deterioration in quality of treated water due to deterioration in membrane is sometimes set to 0.1 mg/L, for example. However, raw water containing the free oxidant at a concentration near the above-described allowable concentration of the remaining free oxidant passes through the reverse osmosis membrane for a long period of time, significant deterioration in the reverse osmosis membrane is caused, and therefore, in actual ultrapure water production, water-to-be-treated to be supplied to a polyamide-based reverse osmosis membrane device is required to hardly contain the remaining free oxidant. Therefore, when the tap water or the like is used as the raw water, it is general that the raw water is treated in an activated carbon device provided at the most pre-stage of the primary pure water production unit to adsorb and remove the oxidant in the raw water, or to the raw water, a reducing agent such as sodium hydrogen sulfite or sodium pyrosulfite is added to cause neutralization, and thereafter the neutralized raw water is set as the water-to-be-treated of reverse osmosis membrane device in the primary pure water production unit.

In the meantime, as a chlorine-resistant reverse osmosis membrane, a cellulose triacetate-based reverse osmosis membrane is used for the technique of desalination of sea water. This chlorine-resistant membrane does not easily deteriorate by an oxidant such as chlorine. However, the deterioration caused by chlorine is easily caused when seawater at 25° C. or more is used, for example, so that a method of reducing a remaining free chlorine concentration in water-to-be-treated has also been proposed (see Patent Reference 3 (J-Patent-A H7-171565), for example).

The solution of a deterioration problem caused by chlorine is expected by using such a chlorine-resistant membrane for the reverse osmosis membrane device in the ultrapure water production system, but the cellulose triacetate-based reverse osmosis membrane has a low impurity removal rate, which is an important function of the reverse osmosis membrane. Therefore, using the cellulose triacetate-based reverse osmosis membrane as the reverse osmosis membrane device in the primary pure water production unit sometimes makes the purity of the primary pure water insufficient.

### SUMMARY OF THE INVENTION

### Problems to be Solved by the Invention

Incidentally, in the reverse osmosis membrane device, when scales are generated on the membrane surface, the water quality of the treated water deteriorates. Therefore, in the reverse osmosis membrane device, a scale inhibitor is sometimes added to the water-to-be-treated in order to suppress generation of scales on the membrane surface. However, adding the scale inhibitor to the water-to-be-treated of the reverse osmosis membrane device causes a problem that biofouling is likely to occur. The biofouling is a phenomenon in which bacteria, microorganisms, or the like in water attach to the membrane surface to block permeation of a stream of water. In the water-to-be-treated resulting from removal of the oxidant by the treatment in the activated carbon device, bacteria or microorganisms are likely to grow. Therefore, it is thought that when the scale inhibitor is added to the water-to-be-treated resulting from removal of the oxidant and the resultant water-to-be-treated is supplied to the reverse osmosis membrane device, bacteria or microorganisms multiply in a state where the water-to-be-treated stays in a flow path of the reverse osmosis membrane device or in a process of the water-to-be-treated flowing through the flow path, and thereby the biofouling occurs.

The present invention has been made in order to solve the above-described problems, and an object thereof is to provide an ultrapure water production method and an ultrapure water production system that are capable of suppressing deterioration in a two-stage reverse osmosis membrane device caused by an oxidant such as free chlorine and at the same time, suppressing occurrence of biofouling by using a chlorine-resistant material as a reverse osmosis membrane to be used for a previous-stage reverse osmosis membrane device in the two-stage reverse osmosis membrane device of the ultrapure water production system and at the same time, by adjusting, for example, a remaining free chlorine concentration in water-to-be-treated of the two-stage reverse osmosis membrane device to a pretreatment range.

### Means of Solving the Problems

An ultrapure water production method of the present invention is an ultrapure water production method using an ultrapure water production system including a two-stage reverse osmosis membrane device, wherein the two-stage reverse osmosis membrane device include a chlorine-resistant reverse osmosis membrane device as a previous-stage reverse osmosis membrane device and a non-chlorine-resistant reverse osmosis membrane device to perform a treatment as a subsequent-stage reverse osmosis membrane device, and the ultrapure water production method includes treating a water-to-be-treated having a total of a free chlorine concentration in Cl equivalent and a free bromine concentration in Br equivalent of 0.01 mg/L or more and less than 0.1 mg/L using the chlorine-resistant reverse osmosis membrane device followed by the non-chlorine-resistant reverse osmosis membrane device of the two-stage reverse osmosis membrane device.

The ultrapure water production method of the present invention further includes: using an activated carbon device to treat a raw water at the previous stage of the two-stage reverse osmosis membrane device; and adjusting a flow velocity of the raw water in the activated carbon device to adjust the total of the free chlorine concentration and the free bromine concentration in the water-to-be-treated preferably.

The ultrapure water production method of the present invention, in which the flow velocity of the raw water in the activated carbon device is 20 h⁻¹ or more and 50 h⁻¹ or less at a space velocity preferably.

The ultrapure water production method of the present invention further includes treating permeated water of the two-stage reverse osmosis membrane device in an electrodeionization device preferably.

The ultrapure water production method of the present invention further includes: adjusting the total of a free chlorine concentration and a free bromine concentration in permeated water of the chlorine-resistant reverse osmosis membrane device to 0.005 mg/L or more and 0.05 mg/L or less preferably.

An ultrapure water production system of the present invention is an ultrapure water production system including a two-stage reverse osmosis membrane device, the ultrapure water production system including: a chlorine-resistant reverse osmosis membrane device functioning as a previous-stage reverse osmosis membrane device of the two-stage reverse osmosis membrane device; a non-chlorine-resistant reverse osmosis membrane device functioning as a subsequent-stage reverse osmosis membrane device of the two-stage reverse osmosis membrane device; and a concentration adjusting unit that adjusts the total of a free chlorine concentration in Cl equivalent and a free bromine concentration in Br equivalent in water-to-be-treated of the chlorine-resistant reverse osmosis membrane device to 0.01 mg/L or more and less than 0.1 mg/L.

The ultrapure water production system of the present invention further includes: an activated carbon device provided at the previous stage of the two-stage reverse osmosis membrane device; and an electrodeionization device provided at the subsequent stage of the two-stage reverse osmosis membrane device preferably.

### Effect of the Invention

According to the ultrapure water production method and the ultrapure water production system of the present invention, it is possible to suppress deterioration in a two-stage reverse osmosis membrane device caused by an oxidant and at the same time, suppress occurrence of biofouling.

### BRIEF DESCRIPTION OF THE DRAWINGS

FIG. 1 is a view schematically illustrating an ultrapure water production system of an embodiment.

FIG. 2 is a view schematically illustrating an ultrapure water production system used in examples.

### MODE FOR CARRYING OUT THE INVENTION

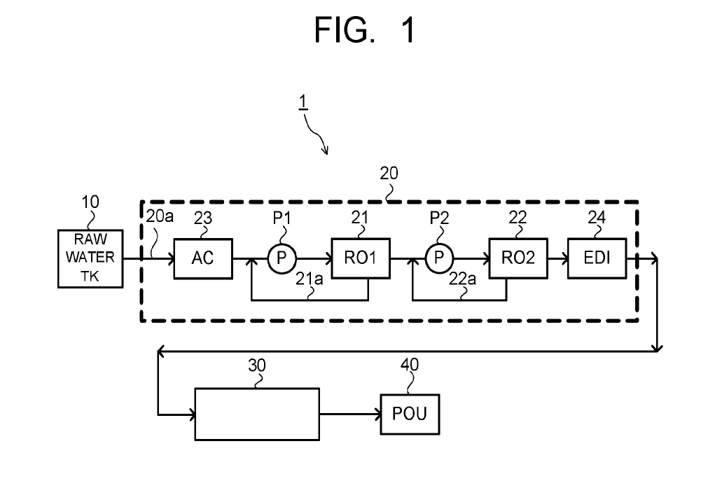

Hereinafter, there will be explained an embodiment in detail with reference to the drawing. FIG. 1 is a view schematically illustrating an ultrapure water production system in the embodiment of the present invention. An ultrapure water production system 1 illustrated in FIG. 1 includes a primary pure water production unit 20 and a secondary pure water production unit 30 on the downstream side of a raw water tank (TK) 10. The primary pure water production unit 20 has a water-to-be-treated flow path 20a through which water-to-be-treated flows. In a path of the water-to-be-treated flow path 20a, a two-stage reverse osmosis membrane device composed of a chlorine-resistant reverse osmosis membrane device (RO1) 21 and a non-chlorine-resistant reverse osmosis membrane device (RO2) 22 that are connected in series is provided. In the path of the water-to-be-treated flow path 20a, a first pump P1 that is provided at a previous stage of the chlorine-resistant reverse osmosis membrane device 21 and adjusts a supply pressure of the water-to-be-treated to the chlorine-resistant reverse osmosis membrane device 21 and a second pump P2 that is provided at a previous stage of the non-chlorine-resistant reverse osmosis membrane device 22 and adjusts a supply pressure of the water-to-be-treated to the non-chlorine-resistant reverse osmosis membrane device 22 are further provided.

The outlet of the chlorine-resistant reverse osmosis membrane device 21 for condensed water is connected to the water-to-be-treated flow path 20a on the upstream side of the first pump P1 through a first condensed water pipe 21a. The water outlet of the non-chlorine-resistant reverse osmosis membrane device 22 for condensed water is connected to the water-to-be-treated flow path 20a between the chlorine-resistant reverse osmosis membrane device 21 and the second pump P2 through a second condensed water pipe 22a.

Further, in the primary pure water production unit 20, in the path of the water-to-be-treated flow path 20a, an activated carbon device (AC) 23 is provided at the previous stage of the chlorine-resistant reverse osmosis membrane device 21 and an electrodeionization device (EDI) 24 is provided at a subsequent stage of the non-chlorine-resistant reverse osmosis membrane device 22. At the primary pure water production unit 20 the raw water is supplied through the water-to-be-treated flow path 20a to the activated carbon device 23 and treated by the activated carbon device 23 to obtain the water-to-be-treated for the chlorine-resistant reverse osmosis membrane device 21. In the primary pure water production unit 20, the water-to-be-treated flow path 20a is the flow path not only for the water-to-be-treated of the chlorine-resistant reverse osmosis membrane device 21 but also for the raw water, permeated water of the reverse osmosis membrane device and so on.

On the downstream side of the primary pure water production unit 20, the secondary pure water production unit 30 is further provided, and the secondary pure water production unit 30 is connected to a point of use (POU) 40 so as to supply generated ultrapure water to the point of use.

In the ultrapure water production system 1, tap water, well water, ground water, and industrial water are used mainly as the raw water. An oxidant such as hypochlorous acid is added to these waters by an oxidant adding device as necessary so that the total of a free chlorine concentration and a free bromine concentration (free oxidant concentration) in raw water becomes 0.1 mg/L to 0.4 mg/L, for example. It is general that this raw water is supplied to the primary pure water production unit 20. Further, as the raw water, water obtained by mixing recovered water into the above-described tap water, well water, ground water, or industrial water may be used.

Incidentally, in this description, the free chlorine concentration is a concentration in which the total amount of chlorine (Cl) in a mode such as a hypochlorite ion (ClO⁻) dissolved in water is represented in chlorine equivalent (as Cl). The free bromine concentration is a concentration in which the total amount of bromine (Br) in a mode such as a hypobromous acid ion (BrO⁻) dissolved in water is represented in bromine equivalent (as Br). Hereinafter, the “total of the free chlorine concentration in Cl equivalent and the free bromine concentration in Br equivalent” will be referred to as a “free oxidant concentration,” and the case where the water contains free chlorine will be explained as an example, but the same is true of the case where the water contains free bromine.

In the ultrapure water production system 1, the free oxidant concentration of the water-to-be-treated of the chlorine-resistant reverse osmosis membrane device 21 is 0.01 mg/L or more and less than 0.1 mg/L. When the free oxidant concentration of the water-to-be-treated of the chlorine-resistant reverse osmosis membrane device 21 is less than 0.01 mg/L, bacteria or microorganisms are likely to be generated in the water-to-be-treated flow path 20a on the downstream side of the chlorine-resistant reverse osmosis membrane device 21. Therefore, biofouling occurs in the chlorine-resistant reverse osmosis membrane device 21 due to long-term use, resulting in a decrease in permeated water flow rate of the chlorine-resistant reverse osmosis membrane device 21. When the free oxidant concentration of the water-to-be-treated of the chlorine-resistant reverse osmosis membrane device 21 is 0.1 mg/L or more, membrane deterioration caused by chlorine is accelerated and the permeated water flow rate of the chlorine-resistant reverse osmosis membrane device 21 increases, resulting in a decrease in impurity removal rate. Therefore, if the free oxidant concentration of the water-to-be-treated of the chlorine-resistant reverse osmosis membrane device 21 is out of the above-described range, it is difficult to maintain a good impurity removal rate over a long period of time. The free oxidant concentration of the water-to-be-treated of the chlorine-resistant reverse osmosis membrane device 21 is preferably 0.02 mg/L to 0.04 mg/L.

In terms of obtaining an excellent impurity removal rate over a long period of time, the pH of the water-to-be-treated of the chlorine-resistant reverse osmosis membrane device 21 is preferred to be 5 to 8 and electrical conductivity is preferred to be 3 μS/cm to 1 mS/cm.

The activated carbon device 23 adsorbs and removes chlorine in the raw water. In the activated carbon device 23, it is possible to adjust the free oxidant concentration of the water-to-be-treated of the chlorine-resistant reverse osmosis membrane device 21 to the above-described range. For example, a pump is provided at a previous stage of the activated carbon device 23, a discharge pressure of the pump is adjusted, and the flow velocity of the raw water in the activated carbon device 23 is controlled, thereby making it possible to adjust the free oxidant concentration of the water-to-be-treated of the chlorine-resistant reverse osmosis membrane device 21. A faster flow velocity of the raw water in the activated carbon device 23 makes the removal rate of chlorine in the activated carbon device 23 small, so that it is possible to increase the free oxidant concentration of the water-to-be-treated of the chlorine-resistant reverse osmosis membrane device 21. On the other hand, a slower flow velocity of the raw water in the activated carbon device 23 makes the removal rate of chlorine in the activated carbon device 23 large, so that it is possible to reduce the free oxidant concentration of the water-to-be-treated of the chlorine-resistant reverse osmosis membrane device 21. In this case, a concentration adjusting unit is composed of the pump provided at the previous stage of the activated carbon device 23, a control device to control the discharge pressure of the pump, and the activated carbon device 23.

Regarding the flow velocity of the raw water in the activated carbon device 23, a space velocity (SV) is preferred to be 20 hr⁻¹ to 50 hr⁻¹ depending on the free oxidant concentration in the raw water. When the space velocity in the activated carbon device 23 is more than 50 hr⁻¹, the free oxidant concentration of the water-to-be-treated of the chlorine-resistant reverse osmosis membrane device 21 sometimes exceeds an optimum value, and when it is less than 20 hr⁻¹, the free oxidant concentration in the water decreases too much, resulting in that bacteria or microorganisms are sometimes likely to multiply in the water-to-be-treated flow path 20a or the like. Incidentally, the free oxidant concentration in the raw water varies, so that an optimum flow velocity according to the free oxidant concentration in the raw water is found by a preparatory experiment or the like to be preferably set as the flow velocity in the activated carbon device 23.

Further, for example, the free oxidant concentration of the water-to-be-treated of the chlorine-resistant reverse osmosis membrane device 21 may be adjusted by providing a bypass pipe that connects the water-to-be-treated flow path 20a before the activated carbon device 23 and the water-to-be-treated flow path 20a after the activated carbon device 23 while bypassing the activated carbon device 23 and by adjusting the flow rate of the raw water flowing through the bypass pipe. In this case, the raw water resulting from removal of chlorine in the water by the treatment in the activated carbon device 23 and the untreated raw water that has flowed through the bypass pipe are mixed, and thereby the free oxidant concentration of the water-to-be-treated of the chlorine-resistant reverse osmosis membrane device 21 is adjusted. The flow rate of the raw water to flow through the bypass pipe can be adjusted by providing an opening variable valve or the like between the bypass pipes and adjusting the opening of the opening variable valve. In this case, the concentration adjusting unit is composed of the bypass pipe connecting the water-to-be-treated flow paths 20a while bypassing the activated carbon device 23, the opening variable valve provided between the bypass pipes to adjust the flow rate of the raw water to flow through the bypass pipe, a control device controlling the opening of the opening variable valve, and the activated carbon device 23.

Further, besides the above-described method, there may be applied a method in which raw water or recovered water whose free oxidant concentration is measured beforehand is supplied to treated water of the activated carbon device 23 in the water-to-be-treated flow path 20a between the activated carbon device 23 and the chlorine-resistant reverse osmosis membrane device 21, to thereby adjust the free oxidant concentration of the water-to-be-treated of the chlorine-resistant reverse osmosis membrane device 21.

The activated carbon device 23 is not essential but can be provided as necessary. When the primary pure water production unit 20 does not include the activated carbon device 23, just before the chlorine-resistant reverse osmosis membrane device 21, a reducing agent supply device to supply a reducing agent is provided to supply a reducing agent that reduces chlorine into the water-to-be-treated flow path 20a, thereby making it possible to adjust the free chlorine concentration of the water-to-be-treated of the chlorine-resistant reverse osmosis membrane device 21. As the reducing agent, a conventional well-known reducing agent such as sodium hydrogen sulfite or sodium pyrosulfite can be used. As the reducing agent supply device, a chemical solution pump that measures a predetermined amount of reducing agent and supplies the measured reducing agent into the water-to-be-treated flow path 20a, or the like can be used.

Further, when the free chlorine concentration in the raw water is too low, an oxidant is supplied into the water-to-be-treated flow path 20a just before the chlorine-resistant reverse osmosis membrane device 21, thereby making it possible to adjust the free chlorine concentration of the water-to-be-treated of the chlorine-resistant reverse osmosis membrane device 21. As the oxidant, hypochlorous acid, hypobromous acid, or the like, which is similar to the one used for sterilizing the raw water, can be used, and the hypochlorous acid is preferred from the viewpoint of cost.

As the method of adjusting the free oxidant concentration of the water-to-be-treated of the chlorine-resistant reverse osmosis membrane device 21, the methods of using the activated carbon device 23 out of the above-described methods are preferred. Recently, for the purpose of improving the safety, reducing the manufacturing cost, reducing the device in size, and so on, there grows a demand for eliminating the use of chemicals as much as possible when manufacturing ultrapure water. Using the activated carbon device 23 enables omission of addition of the above-described reducing agent, so that the methods of using the activated carbon device 23 are suitable for such a demand. Out of the methods of using the activated carbon device 23, the method of adjusting the flow velocity in the activated carbon device 23 makes it possible to achieve the reduction in manufacturing cost and the reduction in size of the device, leading to an improvement in manufacturing efficiency because controlling the discharge pressure of the pump can be performed easily by a well-known method.

In the event of adjustment of the free oxidant concentration of the water-to-be-treated of the chlorine-resistant reverse osmosis membrane device 21, for example, in the case of adjusting the free chlorine concentration, it is also possible that a free chlorine concentration meter is connected to the water-to-be-treated flow path 20a located just before the activated carbon device 23 to measure the free chlorine concentration in the raw water to be supplied to the activated carbon device 23, and then based on a measured value of the free chlorine concentration meter, the flow velocity of the raw water in the activated carbon device 23 is adjusted. As the free chlorine concentration meter, an automatic free chlorine concentration meter that measures the free chlorine concentration automatically to output a measured value is used and further a control device is provided, and thereby the control device can automatically control the discharge pressure of the pump based on the above-described measured value of the free chlorine concentration. This makes it possible to automatically control the free chlorine concentration of the water-to-be-treated of the chlorine-resistant reverse osmosis membrane device 21 to the above-described predetermined range. Incidentally, the control device can also control the entire operation of the ultrapure water production system 1 integrally. The free chlorine concentration can be measured by using a commercially available free chlorine concentration meter such as an active chlorine-DPD Test manufactured by Wako Pure Chemical Corporation or a chlorine concentration meter RC-V1 manufactured by Kasahara Chemical Instruments Corp.

Further, a scale inhibitor may be added to the treated water of the activated carbon device 23 and the resultant treated water may be supplied to the chlorine-resistant reverse osmosis membrane device 21. This makes it possible to suppress generation of scales on the membrane surface of the chlorine-resistant reverse osmosis membrane device 21 and maintain a good impurity removal rate over a long period of time. Scale inhibitors that suppress generation of calcium-based scales such as calcium carbonate, calcium sulfate, calcium sulfite, calcium phosphate, and calcium silicate, magnesium-based scales such as magnesium silicate and magnesium hydroxide, and zinc-based scales such as zinc phosphate, zinc hydroxide, and basic zinc carbonate on the reverse osmosis membrane surface, for example, can be used.

As the scale inhibitor against the calcium-based scales among such scale inhibitors, for example, there can be cited scale inhibitors containing, as active ingredients, inorganic polyphosphates such as sodium hexametaphosphate and sodium tripolyphosphate; phosphonic acids such as aminomethylphosphonic acid, hydroxyethylidene diphosphonic acid, and phosphonobutane tricarboxylic acid; sodium salt, potassium salt, and so on of polycarboxylic acids resulting from polymerization of carboxyl group-containing materials such as, maleic acid, acrylic acid, and itaconic acid; sodium salt, potassium salt, and so on of copolymers resulting from combination of a vinyl monomer in which the carboxyl group-containing material has a sulfonic acid group as necessary and a nonionic vinyl monomer such as acrylamide, and so on.

As a method of adding the scale inhibitor, there is a method to use a device of injecting the scale inhibitor to the water-to-be-treated flow path 20a, for example. As such a device of injecting the scale inhibitor, for example, there can be cited a metering pump that automatically measures chemicals to supply them, an ejector that sucks chemicals by force of high-pressure water from a tank in which the chemicals are stored, or the like to supply them into a pipe, and so on. Further, such a device may also be a device that includes a tank provided between the water-to-be-treated flow paths 20s or connected to the water-to-be-treated flow path 20a and a means to add the scale inhibitor to the tank such as a metering pump, mixes the scale inhibitor into the water-to-be-treated in the tank, and then supplies the water-to-be-treated to the chlorine-resistant reverse osmosis membrane device 21 through the water-to-be-treated flow path 20a.

In the ultrapure water production system 1 in this embodiment, the free oxidant concentration of the water-to-be-treated of the chlorine-resistant reverse osmosis membrane device 21 is adjusted to the above-described optimum range, so that multiplication of bacteria or microorganisms in the chlorine-resistant reverse osmosis membrane device 21 is suppressed significantly even when the scale inhibitor is added to the treated water of the activated carbon device 23, resulting in that it is possible to maintain a good impurity removal rate in the two-stage reverse osmosis membrane device for a long period of time.

The chlorine-resistant reverse osmosis membrane device 21 has a chlorine-resistant reverse osmosis membrane and the chlorine-resistant reverse osmosis membrane is a polyamide-based reverse osmosis membrane, for example. The chlorine-resistant reverse osmosis membrane device 21 has preferred to be a chlorine-resistant polyamide-based composite membrane because its impurity removal rate is high, and is particularly preferred to be a chlorine-resistant cross-linked fully aromatic polyamide-based composite membrane. As the chlorine-resistant cross-linked fully aromatic polyamide-based composite membrane, for example, a membrane having a separating layer formed by interfacial polycondensation of polyfunctional aromatic amine and polyfunctional acid halide, or the like can be used.

In the chlorine-resistant reverse osmosis membrane device 21, a membrane shape of the chlorine-resistant reverse osmosis membrane is a sheet flat membrane, a spiral membrane, a tubular membrane, a hollow fiber membrane, or the like, and is preferred to be the spiral membrane. As a commercial product of the chlorine-resistant reverse osmosis membrane device 21, RE8040CE (product name, manufactured by Toray Industries, Inc.) or the like can be used.

Incidentally, the membrane which the chlorine-resistant reverse osmosis membrane device 21 has, may be another membrane other than the above-described membrane as long as the membrane has chlorine resistance and has a later-described sufficient removal rate of an impurity (boron, NaCl, or the like), for example. The chlorine resistance can be confirmed by immersing the membrane in hypochlorous acid water. For example, it is possible to determine that the reverse osmosis membrane has chlorine resistance when the reverse osmosis membrane is immersed in 10 mg/L of hypochlorous acid water for 150 hours and a decreasing rate of a removal rate of NaCl after immersion is 2% or less and preferably 1% or less providing that the initial removal rate of NaCl is 100%, or when a decreasing rate of a removal rate of boron after immersion is 10% or less and preferably 5% or less providing that the initial removal rate of boron is 100%.

A water recovery rate in the chlorine-resistant reverse osmosis membrane device 21 is preferred to be 50% to 95%, more preferred to be 60% to 90%, and further preferred to be 65% to 85%. When the water recovery rate is within the above-described preferable range, an excellent impurity removal rate is likely to be obtained while suppressing the deterioration in the chlorine-resistant reverse osmosis membrane device 21.

A supply pressure of the water-to-be-treated to the chlorine-resistant reverse osmosis membrane device 21 is preferred to be 0.8 MPa to 2.0 MPa. This is because when the supply pressure of the water-to-be-treated is too small, free chlorine is liable to remain excessively in permeated water resulting from the treatment of the water-to-be-treated having the above-described predetermined free oxidant concentration in the chlorine-resistant reverse osmosis membrane device 21, and when it is too large, the deterioration in the chlorine-resistant reverse osmosis membrane device 21 is likely to be caused.

In terms of producing high-purity ultrapure water, in the chlorine-resistant reverse osmosis membrane device 21, the removal rate of boron (B) is preferred to be 50% to 85% or more and the removal rate of NaCl is preferred to be 95% or more and more preferred to be 99.5% or more. The removal rate of boron is measured as a removal rate of boron obtained when an aqueous solution with 20 μg/L of boron concentration that is 25° C. and has a pH of 7 passes through a reverse osmosis membrane at the allowable maximum operating pressure of the membrane and at a water recovery rate of 15%. Further, the removal rate of NaCl is measured as a removal rate of NaCl obtained when an aqueous solution with 0.2 mass % of NaCl concentration that is 25° C. and has a pH of 7 passes through a reverse osmosis membrane at a water feed pressure of 1.5 MPa and at a water recovery rate of 15%.

The free oxidant concentration of the permeated water of the chlorine-resistant reverse osmosis membrane device 21 is preferred to be 0.005 mg/L to 0.05 mg/L and more preferred to be 0.01 mg/L to 0.02 mg/L. The deterioration in the non-chlorine-resistant reverse osmosis membrane device 22 on the downstream side is more suppressed as long as the free oxidant concentration of the permeated water of the chlorine-resistant reverse osmosis membrane device 21 is 0.05 mg/L or less. When the deterioration in the non-chlorine-resistant reverse osmosis membrane device 22 progresses, removal rates of boron, silica, and so on decrease early even though removal rates of alkali metal ions such as Na and Ca, an alkaline-earth metal ion, and anions such as SO₄²⁻ and do not decrease, resulting in that the boron concentration of the ultrapure water at the end increases or the load of boron in a subsequent-stage device increases.

The condensed water of the chlorine-resistant reverse osmosis membrane device 21 may be made to flow back to the upstream side of the first pump p1 through the first condensed water pipe 21a to be treated again in the chlorine-resistant reverse osmosis membrane device 21. An array may be made by using a plurality of reverse osmosis membrane modules so as to treat the condensed water of the chlorine-resistant reverse osmosis membrane device 21 in another reverse osmosis membrane device to thereby make the condensed water of the chlorine-resistant reverse osmosis membrane device 21 pass through the array. Thereby, the water recovery rate in the two-stage reverse osmosis membrane device further improves.

The permeated water treated in the chlorine-resistant reverse osmosis membrane device 21 in this manner is supplied to the non-chlorine-resistant reverse osmosis membrane device 22.

A reverse osmosis membrane provided in the non-chlorine-resistant reverse osmosis membrane device 22 is a non-chlorine-resistant reverse osmosis membrane that does not have chlorine resistance. The non-chlorine-resistant reverse osmosis membrane has a high impurity removal rate, thereby making it possible to produce high-purity ultrapure water. The non-chlorine-resistant reverse osmosis membrane is, for example, a polyamide-based membrane, a polyvinyl alcohol-based membrane, or a polysulfone-based membrane, and is preferred to be a polyamide-based composite membrane and more preferred to be a cross-linked fully aromatic polyamide-based composite membrane. The non-chlorine-resistant reverse osmosis membrane is a sheet flat membrane, a spiral membrane, a tubular membrane, a hollow fiber membrane, or the like in terms of a membrane shape, and is preferred to be the spiral membrane. As a commercial product of the non-chlorine-resistant reverse osmosis membrane device 22, TMG20, TM720, TM800K, TM820 (product name, each manufactured by Toray Industries, Inc.), BW30 and SW30 (product name, manufactured by The Dow Chemical Company), and so on can be used.

A water recovery rate in the non-chlorine-resistant reverse osmosis membrane device 22 is preferred to be 50% to 95%, more preferred to be 60% to 90%, and further preferred to be 65% to 85%. When the water recovery rate is in the above-described preferred range, an excellent impurity removal rate is obtained easily while suppressing the deterioration in the non-chlorine-resistant reverse osmosis membrane device 22.

A supply pressure of the water-to-be-treated for the non-chlorine-resistant reverse osmosis membrane device 22 in the non-chlorine-resistant reverse osmosis membrane device 22 is preferred to be 0.8 MPa to 2.0 MPa. This is because when the supply pressure of the water-to-be-treated in the non-chlorine-resistant reverse osmosis membrane device 22 is too small, impurities sometimes remain excessively in the permeated water, and when it is too large, the deterioration in the non-chlorine-resistant reverse osmosis membrane device 22 is likely to be caused.

In terms of producing high-purity ultrapure water, in the non-chlorine-resistant reverse osmosis membrane device 22, the removal rate of boron (B) is preferred to be 50% to 90% and the removal rate of NaCl is preferred to be 95% or more and more preferred to be 99.5% or more. The removal rate of boron and the removal rate of NaCl are each measured by the same method as that of the above-described chlorine-resistant reverse osmosis membrane device 21.

The electrodeionization device 24 removes ion components in the permeated water treated in the non-chlorine-resistant reverse osmosis membrane device 22. The electrodeionization device 24 includes an anion-exchange membrane and a cation-exchange membrane arranged alternately between a cathode and an anode, for example. Further, the electrodeionization device 24 includes a demineralization chamber partitioned by the anion-exchange membrane and the cation-exchange membrane and a condensation chamber into which condensed water containing the removed ion components flows alternately. The electrodeionization device 24 includes a mixture of an anion exchange resin and a cation exchange resin filled in the demineralization chamber and an electrode for applying a direct-current voltage.

In the electrodeionization device 24, for example, the water-to-be-treated for the electrodeionization device 24 is concurrently supplied to the demineralization chamber and the condensation chamber and the mixture of the anion exchange resin and the cation exchange resin in the demineralization chamber adsorbs the ion components in the water-to-be-treated. The adsorbed ion components are moved into the condensation chamber by an action of the direct-current voltage and the condensed water in the condensation chamber is discharged to the outside of the system.

The electrodeionization device 24 can remove ion components continuously without using such chemicals as acid and alkali, which aim at reproducing the ion exchange resins, at all. Therefore, it is possible to achieve the improvement in safety, the reduction in manufacturing cost, the reduction in size of the device, and so on in the ultrapure water production, leading to an improvement in manufacturing efficiency. The electrodeionization device 24 may be a multistage electrodeionization device composed of a plurality of electrodeionization devices connected in series.

The electrodeionization device 24 is not essential but is provided as necessary. The primary pure water production unit 20 may include a nonreproducing-type mixed bed ion exchange resin device (Polisher) in place of the electrodeionization device 24. The nonreproducing-type mixed bed ion exchange resin device includes a cation exchange resin and an anion exchange resin mixed and filled in a container and can remove ion components in the permeated water of the non-chlorine-resistant reverse osmosis membrane device 22. The nonreproducing-type mixed bed ion exchange resin device does not reproduce the ion exchange resins filled inside and is replaced when performance of removing ion components decreases, thus not using such chemicals as acid and alkali. Therefore, according to the nonreproducing-type mixed bed ion exchange resin device, the use of chemicals can be reduced, so that it is possible to achieve the improvement in safety, the reduction in manufacturing cost, the reduction in size of the device, and so on in the ultrapure water production, leading to an improvement in manufacturing efficiency.

Further, the primary pure water production unit 20 may use a reproducing-type mixed bed ion exchange resin device, which is a device associated with the use of chemicals, in place of the electrodeionization device 24.

In this manner, the primary pure water production unit 20 removes ion components and nonionic components in the pre-treated water to produce primary pure water. The primary pure water has a TOC concentration of 10 μgC/L or less and has specific resistivity of 17 MΩ·cm or more, for example.

The secondary pure water production unit 30 is a device to remove minor impurities in the primary pure water, and is composed of an ultraviolet oxidation device, a membrane deaeration device, a nonreproducing-type mixed bed ion exchange device, an ultrafiltration device, and so on. The ultrapure water obtained by this has, for example, a TOC concentration of 5 μgC/L or less and has specific resistivity of 17.5 MΩ·cm or more in which the concentration of boron is reduced down to 1 ng/L or less.

According to the ultrapure water production system 1 and the ultrapure water production method in the embodiment explained above, it is possible to obtain an excellent impurity removal rate over a long period of time while suppressing occurrence of biofouling in the reverse osmosis membrane device and at the same time, suppressing deterioration in the reverse osmosis membrane caused by the oxidant.

### Example

Next, there will be explained examples. The present invention is not limited to the following examples.

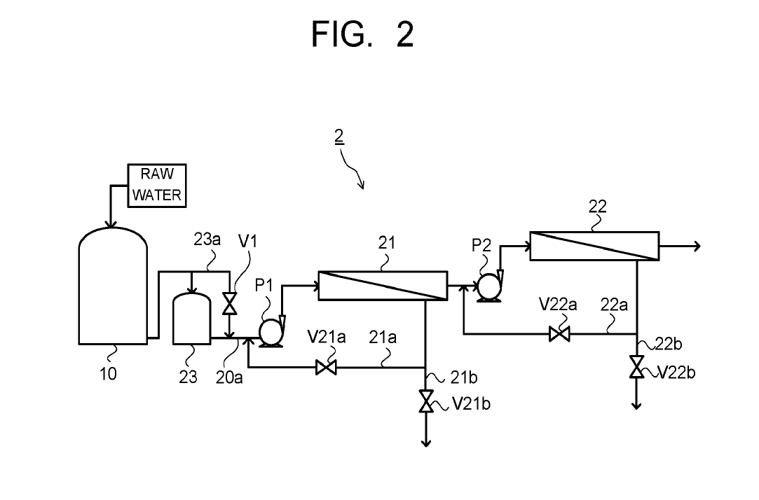

FIG. 2 is a view schematically illustrating an ultrapure water production system 2 used in the examples. In the ultrapure water production system 2 illustrated in FIG. 2, the same reference numerals and symbols are added to the components common to those in the ultrapure water production system 1 illustrated in FIG. 1, and their overlapping explanations are omitted. The ultrapure water production system 2 illustrated in FIG. 2 includes the activated carbon device 23 that treats raw water, the chlorine-resistant reverse osmosis membrane device 21, and the non-chlorine-resistant reverse osmosis membrane device 22. At the previous stage of the chlorine-resistant reverse osmosis membrane device 21, the first pump P1 is provided, and at the previous stage of the non-chlorine-resistant reverse osmosis membrane device 22, the second pump P2 is provided. Further, in the water-to-be-treated flow path 20a, a bypass pipe 23a that bypasses the activated carbon device 23 is provided. An opening variable valve V1 is provided between the bypass pipes 23a.

The specifications of the device used in the examples and water passing conditions are as follows.

The activated carbon device 23: Diahope M006LFA manufactured by Calgon Mitsubishi Chemical Corporation
The chlorine-resistant reverse osmosis membrane device 21: Use one piece of RE8040-CE manufactured by Toray Industries, Inc. The water recovery rate: 75%. Feedback control the first pump P1 by the permeated water pressure of the chlorine-resistant reverse osmosis membrane device 21 and operate it at a substantially constant operating pressure of 1.2 MPa.
The non-chlorine-resistant reverse osmosis membrane device 22: Use one piece of TM720 manufactured by Toray Industries, Inc. The water recovery rate: 75%. Feedback control the second pump P2 by the permeated water pressure of the non-chlorine-resistant reverse osmosis membrane device 22 and operate it at a substantially constant operating pressure of 1.2 MPa.

The condensed water of the chlorine-resistant reverse osmosis membrane device 21 was made to flow back to the water-to-be-treated flow path 20a on the upstream side of the first pump P1. The condensed water of the non-chlorine-resistant reverse osmosis membrane device 22 was made to flow back to the water-to-be-treated flow path 20a between the chlorine-resistant reverse osmosis membrane device 21 and the second pump P2. An opening variable valve V21a was provided between first condensed water pipes 21a and an opening variable valve V22a was provided between second condensed water pipes 22a respectively. Further, a first condensed water discharge pipe 21b was connected to the first condensed water pipe 21a via an opening variable valve V21b. A second condensed water discharge pipe 22b was connected to the second condensed water pipe 22a via an opening variable valve V22b. The opening variable valves V21a, V22a, V21b, and V22b adjusted the amount of the condensed water to be made to flow back to the water-to-be-treated flow path 20a from the first condensed water pipe 21a and the second condensed water pipe 22a. Part of the condensed water of the chlorine-resistant reverse osmosis membrane device 21 was discharged to the outside of the system through the first condensed water discharge pipe 21b and part of the condensed water of the non-chlorine-resistant reverse osmosis membrane device 22 was discharged to the outside system through the second condensed water discharge pipe 22b respectively.

As the raw water, atsugi tap water in Atsugi city Kanagawa prefecture (pH=8.1, sodium (Na) concentration of 13 mg/L, boron (B) concentration of 20 μg/L, and conductivity of 185 μS/cm) was used. The treated raw water resulting from decomposition of hypochlorous acid in the raw water by a treatment in the activated carbon device 23 and the untreated raw water that flowed through the bypass pipe 23a were mixed. Water-to-be-treated at a free chlorine concentration set in each example illustrated in Table 1 while adjusting the opening of the opening variable valve V1 in the bypass pipe 23a was supplied to the chlorine-resistant reverse osmosis membrane device 21. The free chlorine concentration of the water-to-be-treated of the chlorine-resistant reverse osmosis membrane device 21 was measured by a chlorine concentration meter RC-V1 manufactured by Kasahara Chemical Instruments Corp. by sampling the water-to-be-treated in the water-to-be-treated flow path 20a located immediately before the chlorine-resistant reverse osmosis membrane device 21. The pH of the water-to-be-treated was 8.0.

The Na concentration and the B concentration in the permeated water of each of the chlorine-resistant reverse osmosis membrane device 21 and the non-chlorine-resistant reverse osmosis membrane device 22 in an early period of water passing were measured to calculate the Na removal rate and the B removal rate of each of the chlorine-resistant reverse osmosis membrane device 21 and the non-chlorine-resistant reverse osmosis membrane device 22. Further, the permeated water flow rate of each of the chlorine-resistant reverse osmosis membrane device 21 and the non-chlorine-resistant reverse osmosis membrane device 22 in the early period of water passing was measured. The Na concentration was measured by ICP emission spectrography and the B concentration was measured by LC/MS/MS (liquid chromatography mass spectrometry).

Thereafter, after 10000 hours since start of supply of the raw water to the ultrapure water production system 2, the Na concentration and the B concentration in the permeated water of each of the chlorine-resistant reverse osmosis membrane device 21 and the non-chlorine-resistant reverse osmosis membrane device 22 were measured in the same manner as in the early period of water passing to calculate each Na removal rate and each B removal rate. Further, the permeated water flow rate of each of the chlorine-resistant reverse osmosis membrane device 21 and the non-chlorine-resistant reverse osmosis membrane device 22 was measured. Results are illustrated in Table 1. Incidentally, in Table 1, the permeated water flow rate of each of the chlorine-resistant reverse osmosis membrane device 21 and the non-chlorine-resistant reverse osmosis membrane device 22 after 10000 hours since start of supply of the raw water to the ultrapure water production system 2 is a value resulting from calculation by setting the permeated water flow rate in the early period of water passing to one.

TABLE 1

| | | RO1 (Chlorine-resistance) | | | | RO2 (Non-chlorine-resistance) | | | | | |
|---|---|---|---|---|---|---|---|---|---|---|---|
| | | Free Cl | | | | Free Cl | | | | Ultrapure water | |
| | | concentration | | | | concentration | | | | production system | |
| | | of water-to- | Na | B | Permeated | of water-to- | Na | B | Permeated | | Permeated |
| | | be-treated | removal | removal | water flow | be-treated | removal | removal | water flow | B | water flow |
| | | of RO1 | rate | rate | rate | of RO2 | rate | rate | rate | concentration | rate |
| | | mg/L(as Cl) | % | % | Times | mg/L(as Cl) | % | % | Times | μg/L | Times |
| Example 1 | Early period | 0.005 | 98.8 | 61 | — | 0.0028 | 98.8 | 55 | — | 3.5 | — |
| | of water | | | | | | | | | | |
| | passing | | | | | | | | | | |
| | After 10000 | | 98.0 | 35 | 0.7 | 0.0025 | 98.0 | 49 | 1.0 | 6.6 | 0.7 |
| | hours | | | | | | | | | | |
| Example 2 | Early period | 0.01 | 98.8 | 61 | — | 0.005 | 98.8 | 55 | — | 3.5 | — |
| | of water | | | | | | | | | | |
| | passing | | | | | | | | | | |
| | After 10000 | | 98.5 | 56 | 0.9 | 0.005 | 98.5 | 53 | 1.0 | 4.1 | 0.9 |
| | hours | | | | | | | | | | |
| Example 3 | Early period | 0.02 | 98.8 | 61 | — | 0.01 | 98.8 | 55 | — | 3.5 | — |
| | of water | | | | | | | | | | |
| | passing | | | | | | | | | | |
| | After 10000 | | 98.8 | 61 | 1.0 | 0.01 | 98.8 | 55 | 1.0 | 3.5 | 1.0 |
| | hours | | | | | | | | | | |
| Example 4 | Early period | 0.04 | 98.8 | 61 | — | 0.02 | 98.8 | 55 | — | 3.5 | — |
| | of water | | | | | | | | | | |
| | passing | | | | | | | | | | |
| | After 10000 | | 98.8 | 61 | 1.0 | 0.02 | 98.0 | 55 | 1.0 | 3.5 | 1.0 |
| | hours | | | | | | | | | | |
| Example 5 | Early period | 0.08 | 98.8 | 61 | — | 0.04 | 98.8 | 55 | — | 3.5 | — |
| | of water | | | | | | | | | | |
| | passing | | | | | | | | | | |
| | After 10000 | | 98.5 | 52 | 1.1 | 0.04 | 98.5 | 51 | 1.1 | 4.7 | 1.2 |
| | hours | | | | | | | | | | |
| Example 6 | Early period | 0.2 | 98.8 | 61 | — | 0.10 | 98.8 | 55 | — | 3.5 | — |
| | of water | | | | | | | | | | |
| | passing | | | | | | | | | | |
| | After 10000 | | 98.0 | 29 | 1.5 | 0.11 | 98.0 | 26 | 1.5 | 10.5 | 2.3 |
| | hours | | | | | | | | | | |

Table 1 reveals that in Examples 2 to 5 where the free chlorine concentration of the water-to-be-treated of the chlorine-resistant reverse osmosis membrane device 21 was set to 0.01 mg/L or more and less than 0.1 mg/L, after 10000-hour water passing, the Na removal rate, the B removal rate, and the permeated water flow rate of both of the chlorine-resistant reverse osmosis membrane device 21 and the non-chlorine-resistant reverse osmosis membrane device 22 all were the same as those in the early period.

In contrast to this, in Example 1 where the free chlorine concentration of the water-to-be-treated of the chlorine-resistant reverse osmosis membrane device 21 was less than 0.01 mg/L, a decrease in the permeated water flow rate, a slight decrease in the Na removal rate, and a decrease in the B removal rate were seen in the chlorine-resistant reverse osmosis membrane device 21. This is inferred because bacteria attached to the membrane surface. Further, in Example 6 where the free chlorine concentration of the water-to-be-treated of the chlorine-resistant reverse osmosis membrane device 21 was 0.1 mg/L or more, an increase in the permeated water flow rate, a slight decrease in the Na removal rate, and a decrease in the B removal rate were seen in the chlorine-resistant reverse osmosis membrane device 21. This is inferred because the membrane deteriorated by chlorine.

From the above, according to the ultrapure water production system and the ultrapure water production method of the present invention, it is found out that it is possible to obtain an excellent removal rate of an impurity (boron, in particular) over a long period of time by suppressing generation of bacteria or microorganisms in the reverse osmosis membrane device and at the same time, suppressing deterioration in the reverse osmosis membrane caused by the oxidant such as free chlorine.

What is claimed is:

1. An ultrapure water production method using an ultrapure water production system including a two-stage reverse osmosis membrane device, wherein
the two-stage reverse osmosis membrane device include a chlorine-resistant reverse osmosis membrane device as a previous-stage reverse osmosis membrane device and a non-chlorine-resistant reverse osmosis membrane device to perform a treatment as a subsequent-stage reverse osmosis membrane device, and
the ultrapure water production method comprises
treating a water-to-be-treated having a total of a free chlorine concentration in Cl equivalent and a free bromine concentration in Br equivalent of 0.01 mg/L or more and less than 0.1 mg/L using the chlorine-resistant reverse osmosis membrane device followed by the non-chlorine-resistant reverse osmosis membrane device of the two-stage reverse osmosis membrane device.

2. The ultrapure water production method according to claim 1, further comprising:
treating a raw water using an activated carbon device to obtain the water-to-be-treated through adjusting a flow velocity of the raw water in the activated carbon device.

3. The ultrapure water production method according to claim 2, wherein
the flow velocity of the raw water in the activated carbon device is 20 or more and or less at a space velocity.

4. The ultrapure water production method according to claim 1, further comprising:
treating a permeated water of the two-stage reverse osmosis membrane device in an electrodeionization device.

5. The ultrapure water production method according to claim 1, further comprising:
adjusting a total of a free chlorine concentration and a free bromine concentration in permeated water of the chlorine-resistant reverse osmosis membrane device to 0.005 mg/L or more and 0.05 mg/L or less.

6. An ultrapure water production system including a two-stage reverse osmosis membrane device, the ultrapure water production system comprising:
a chlorine-resistant reverse osmosis membrane device functioning as a previous-stage reverse osmosis membrane device of the two-stage reverse osmosis membrane device;
a non-chlorine-resistant reverse osmosis membrane device functioning as a subsequent-stage reverse osmosis membrane device of the two-stage reverse osmosis membrane device; and
a concentration adjusting unit that adjusts a total of a free chlorine concentration in Cl equivalent and a free bromine concentration in Br equivalent in a water-to-be-treated of the chlorine-resistant reverse osmosis membrane device to 0.01 mg/L or more and less than 0.1 mg/L.

7. The ultrapure water production system according to claim 6, further comprising:
an activated carbon device provided at the previous stage of the two-stage reverse osmosis membrane device; and
an electrodeionization device provided at the subsequent stage of the two-stage reverse osmosis membrane device.
